(19) United States
(12) Patent Application Publication
(10) Pub. No.: US 2014/0023167 A1
(43) Pub. Date: Jan. 23, 2014

(54) METHOD AND DEVICE FOR ESTIMATING GAIN AND PHASE CORRECTION PARAMETERS WHEN RECEIVING AN OFDM MODULATED SIGNAL

(71) Applicant: STMicroelectronics (Grenoble 2) SAS, Grenoble (FR)

(72) Inventor: Jacques Meyer, Saint Martin Le Vinoux (FR)

(73) Assignee: STMicroelectronics (Grenoble 2) SAS, Grenoble (FR)

(21) Appl. No.: 13/948,020

(22) Filed: Jul. 22, 2013

(30) Foreign Application Priority Data
Jul. 23, 2012 (FR) 12/57122

(51) Int. Cl. H04L 27/26

(52) U.S. Cl. CPC H04L 27/265
USPC 375/343

(57) ABSTRACT

Gain and phase correction parameters are estimated by calculating the error between the value of at least one received bin and a probable value of the transmitted bin, and by correlating this error with the conjugate value of the rotationally compensated symmetrized bin.

### CROSS REFERENCE TO RELATED APPLICATIONS

This application claims the priority benefit of French patent application serial number 12/57122, filed on Jul. 23, 2012, which is hereby incorporated by reference to the maximum extent allowable by law.

### BACKGROUND

1. Technical Field

The disclosure relates to the processing of modulated signals, and more particularly to the estimation and correction of imbalances (a term well known to a person skilled in the art) between the I and Q channels of the reception chain of such a signal.

The disclosure is particularly applicable to signals modulated by a quadrature digital modulation on a large number of orthogonal carriers (OFDM modulation: Orthogonal Frequency Division Multiplexing, according to the term currently used by a person skilled in the art).

The disclosure applies advantageously but not restrictively to signals meeting the MoCA (Multimedia over Coax Alliance) standard, received via coaxial cables and intended, for example, for multimedia devices in a home network.

2. Discussion of the Related Art

In a reception chain of a received complex modulated signal, the baseband signal is deduced from the received radio frequency signal by at least one frequency transposition to a frequency as close as possible to the frequency of the transmission carrier. This is often done in the analog domain and the conventional in-phase and quadrature (I and Q) components undergo operations physically performed by separate, therefore inevitably different, hardware. This results in a deterioration of the signal, which may optionally be corrected, on condition of knowing how to detect and measure these gain and quadrature imbalances between these I and Q channels.

U.S. Pat. No. 7,109,787 discloses a solution for detecting and correcting these imbalances in the case of single-carrier signals.

However, estimating these correction parameters is particularly difficult, especially in OFDM transmissions, and more particularly in network applications, e.g. those that conform to the MoCA specification, since these imbalance parameters may change with each new transaction.

The article by Ron Parrot and Fred Harris entitled “Resolving and correcting gain and phase mismatch in transmitters and receivers for wide band OFDM systems”, IEEE 2002, pp. 1005-1009, describes a solution for estimating these imbalance parameters in the case of an OFDM transmission. However, this solution provides for the use of specific symbols dedicated to such estimation and requires the use of a large number of symbols for a considerable time.

### SUMMARY

According to one embodiment, a method and a device are provided for estimating gain and quadrature imbalance parameters, which can be performed on a single OFDM symbol, in practice on a plurality of OFDM symbols for better accuracy, and using OFDM symbols not specifically dedicated to this estimation.

According to one embodiment, this estimation is based on the fact that the noise on the carrier modulation coefficient (commonly termed by a person skilled in the art as the “bin”) k is correlated with the symmetric bin N-k, taking into account the phase shift between the signal received and the signal entering the Fourier transform operator. In other words, these parameters can be estimated by studying the correlation of the error vector between a received bin and the probable value of the corresponding transmitted bin with the inverted spectrum of the signal taking into account the rotation applied to each symbol prior to Fourier transform processing.

According to one embodiment, a method is provided for processing an analog signal received from a transmission channel and modulated by a modulation on N carriers, such as an OFDM modulation; the received signal carries a succession of symbols of size N each comprising N complex modulation coefficients (or “bins”) respectively associated with the N carriers;

the method comprises at least one frequency transposition on two phase quadrature processing channels, an analog-to-digital conversion of the transposed signal, and digital processing of the converted signal;

this digital processing comprises Fourier transform processing of size N preceded by a gain and quadrature correction using a gain correction parameter and a phase correction parameter, and a phase shift correction (derotation) between the signal received and the signal processed by Fourier transform;

the Fourier transform processing is further followed by an estimation of said gain and phase correction parameters, this estimation including, for at least one modulation coefficient received within at least one symbol and associated with a first carrier,

a calculation of the error between the value of this received modulation coefficient and a probable value of the transmitted corresponding modulation coefficient weighted by the corresponding coefficient of the transmission channel transfer function (channel distortion coefficient), and

a correlation of this error with the complex conjugate value of the transmitted symmetric modulation coefficient weighted by the corresponding coefficient of the transmission channel transfer function, taking said phase shift into account.

For a modulation coefficient, or bin, of index p, associated with the carrier p, the symmetric modulation coefficient is the modulation coefficient of index N-p associated with the carrier N-p having a symmetric frequency of frequency p associated with bin p with respect to the central carrier frequency.

Although this estimation may be made on a single bin of a single symbol, it is preferable that it is carried out on a plurality of bins or even all the bins of at least one symbol.

As a variant, this estimation can be made for at least a plurality of bins or even all the bins, respectively received within a plurality of symbols, e.g. M symbols.

The probable value of each transmitted corresponding modulation coefficient may be a previously known value in the case where known symbols are used.

However, generally the digital processing of the converted signal includes, subsequently to the Fourier transform, transformation processing (demapping) of the binary information symbols, optionally followed by error correction processing (of the FEC, Forward Error Correction, type). In this case, as a variant, the probable value of a transmitted modulation coefficient may be a value reconstituted from the binary information obtained from the transformation processing (demapping) applied to the symbol containing the received corresponding modulation coefficient, after optionally applying correction processing.

In the event of a large frequency shift in the frequency transposition operation, the symbol may rotate through a considerable angle between its first and last sample, creating an interference between the carriers. Furthermore, it is particularly advantageous that, prior to the calculation of the error vector between the received bin and the probable value of the transmitted bin weighted by the corresponding channel distortion coefficient, a correction is made to the value of the corresponding received modulation coefficient, by using an interpolation from the values of the received modulation coefficients associated with the neighboring carriers of the carrier associated with the modulation coefficient in question.

According to another aspect, a device is provided for estimating a gain correction parameter and a phase correction parameter, said parameters being usable in a gain and quadrature correction stage for correcting two quadrature processing channels of a transposed digital signal originating from an analog signal received from a transmission channel and modulated by a modulation on N carriers, said received signal carrying a succession of symbols of size N each comprising N complex modulation coefficients respectively associated with the N carriers;

the estimation device comprises an estimation module capable of being coupled to a Fourier transform module of size N coupled upstream to said gain and quadrature correction stage and to a stage for correcting the phase shift between the signal received and the signal processed by the Fourier transform module;

the estimation module is configured for performing an estimation of said gain and phase correction parameters including, for at least one modulation coefficient received within at least one symbol and associated with a first carrier,

a calculation of the error between the value of this received modulation coefficient and a probable value of the transmitted corresponding modulation coefficient weighted by the corresponding coefficient of the transmission channel transfer function, and

a correlation of this error with the complex conjugate value of the transmitted symmetric modulation coefficient weighted by the corresponding coefficient of the transmission channel transfer function, taking said phase shift into account.

According to one embodiment, the estimation module is further configured for performing said estimation including, for at least a plurality of complex modulation coefficients received within at least one symbol and respectively associated with first carriers,

a calculation of the errors between the values of these received modulation coefficients and the probable values of the transmitted corresponding modulation coefficients weighted by the corresponding coefficients of the transmission channel transfer function, and

a correlation of these errors with the complex conjugate values of the transmitted respective symmetric modulation coefficients weighted by the corresponding coefficients of the transmission channel transfer function, taking said phase shift into account.

According to one embodiment, the estimation module is further configured for performing said estimation including, for at least a plurality of complex modulation coefficients respectively received within a plurality of symbols and respectively associated with first carriers,

a calculation of the errors between the values of these received modulation coefficients and the probable values of the transmitted corresponding modulation coefficients weighted by the corresponding coefficients of the transmission channel transfer function, and

a correlation of these errors with the complex conjugate values of the transmitted respective symmetric modulation coefficients weighted by the corresponding coefficients of the transmission channel transfer function, taking said phase shift into account.

According to one embodiment, the probable value of each transmitted corresponding modulation coefficient is a value previously known or a value reconstituted from binary information, optionally corrected by correction processing, and obtained from binary information symbol transformation processing applied to the symbol containing the received corresponding modulation coefficient.

According to one embodiment, the device further includes a correction block configured for making a correction to the value of the corresponding received modulation coefficient by using an interpolation from the values of the received modulation coefficients associated with the neighboring carriers of the carrier associated with the modulation coefficient in question, and supplying said corrected value to the estimation module.

According to an embodiment, a reception chain is provided, including

an input coupled to a transmission channel and configured for receiving an analog signal modulated according to a modulation on N carriers, said received signal carrying a succession of symbols of size N each comprising N complex modulation coefficients respectively associated with the N carriers,

frequency transposition means configured for performing at least one frequency transposition on two phase quadrature processing channels,

conversion means configured for performing an analog-to-digital conversion of the transposed signal, and

digital processing means coupled to the output of the conversion means and comprising a Fourier transform module of size N coupled upstream to a gain and quadrature correction stage using a gain correction parameter and a phase correction parameter and to a stage for correcting the phase shift between the signal received and the signal processed by the Fourier transform module, and coupled downstream to an estimation device as defined previously.

According to another embodiment, a device is provided including a reception chain as defined previously.

### BRIEF DESCRIPTION OF THE DRAWINGS

Other advantages and features of the invention will appear on examination of the detailed description of modes of implementation and embodimentS, in no way restrictive, and of the attached drawings in which:

FIGS. 1 to 4 schematically illustrate various embodiments and implementations.

### DETAILED DESCRIPTION

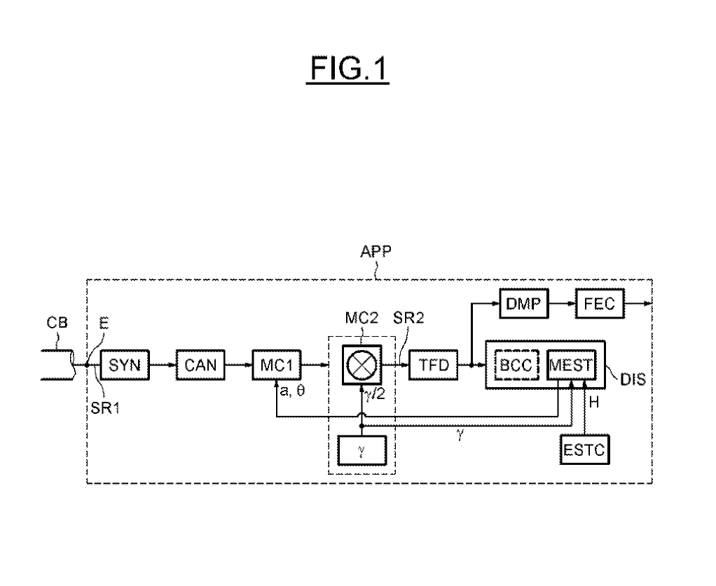

In FIG. 1, the reference APP refers to an apparatus with an input E connected in the example described here to a coaxial cable CB and intended to receive a signal modulated according to a modulation of the OFDM type, e.g. compliant with the MoCA standard.

Each OFDM symbol having a duration T comprises packets of N bins A_{p,i}. Bins are complex numbers defined from binary information to be transmitted by a constellation often with QAM type modulation of 4, 16, 64, 2^{q} states.

The bin of index p, with p varying from 0 to N-1, modulates the carrier frequency fₚ.

The space between two adjacent frequencies of adjacent carriers is taken as equal to 1/T thus making the frequencies orthogonal.

The frequency fₚ of the carrier p is therefore equal to f₀+p/T where f₀ is the carrier frequency 0.

The apparatus APP comprises first, a tuner SYN intended chiefly for performing at least one frequency transposition for bringing the modulated, generally radio frequency, signal back into a complex baseband signal. The baseband analog signal is then converted into a digital signal in a (dual) analog-to-digital converter CAN.

The analog-to-digital converter CAN is followed by a gain and quadrature correction stage MC1 for correcting the gain imbalance of the two I and Q channels, and the quadrature imbalance of the two I and Q channels. Accordingly, the correction stage MC1 receives a gain correction parameter a and a phase correction parameter θ and applies a correction matrix to the signal which may, for example, be the following matrix MC:

$$MC = [ \begin{matrix}1 + a & θ \\ θ & 1 - a\end{matrix} ]$$

The correction stage MC1 is followed by a stage MC2 for correcting the phase shift between the received signal SR1 and the signal SR2 processed by a Fourier transform module TFD, here of size N, coupled downstream from the correction stage MC2.

This correction stage MC2 is also known to the person skilled in the art under the term “derotator” since it performs a derotation correction of I and Q components of the signal by multiplying these components by the complex number e^{-jγ/2} where γ/2 is the angle of derotation defined by the following formula (1):

γ/2=(ωᵣ−ωₑ)t+φ (1)

in which ωᵣ denotes the angular frequency of the transmission modulation carrier and ωᵣ denotes the angular frequency of the transposed signal.

φ denotes a phase shift of unknown origin.

The parameter γ is thus twice the derotation angle in the middle of the symbol and is conventionally obtained, for example, by using pilot symbols during a learning phase. Such a stage or derotator MC2 is of conventional structure and known in itself and may be, for example, that disclosed in European patent application No. 0 481 543.

As stated previously, the derotator MC2 is connected to a Fourier transform module of size N, referenced TFD, followed conventionally by a means DMP performing transformation processing of binary information symbols. Such a means is also known to the person skilled in the art under the term “demapper”. The demapper is generally followed by a module FEC for performing error correction processing on the bits delivered by the demapper.

In addition to the means that have just been described, the reception chain of the apparatus APP comprises a device DIS for estimating the gain correction parameter a and the phase correction parameter θ based, particularly as will be seen in further detail below, on taking into account the parameter γ and the transfer function H of the transmission channel, here the coaxial cable CB. This transfer function represents the channel distortion.

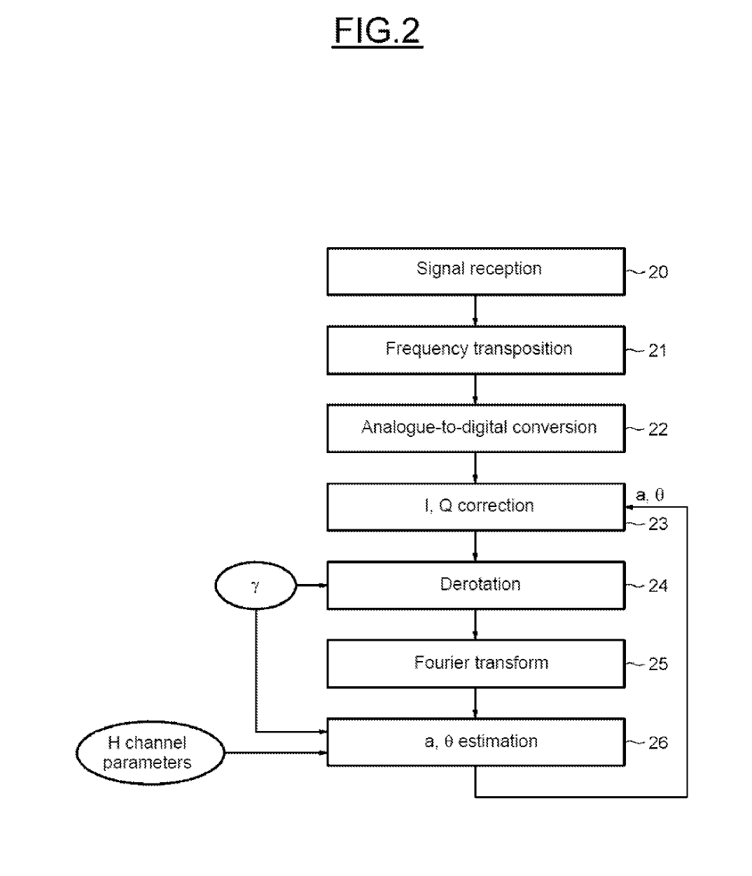

In general, as shown in FIG. 2, the processing of the received analog signal SR1 first of all comprises reception of this signal (step 20) followed by at least one frequency transposition 21 performed in the tuner SYN.

Then, an analog-to-digital conversion 22 is performed and gain and quadrature imbalance correction 23 is carried out using the correction parameters a and θ.

The signal thus corrected undergoes a derotation 24 then a Fourier transform 25. The estimation 26 of the parameters a and θ is performed at the output of the Fourier transform 25 from the parameter γ which is double the derotation angle in the middle of an OFDM symbol and from the coefficients Hᵢ of the channel transfer function.

In practice, the system converges after a few iterations.

A more detailed description will now be given of a method of implementing the estimation 26 of parameters a and θ.

A sequence of M known OFDM symbols is considered here. In practice, these symbols may precede an exchange of data, e.g. in the MoCA standard, the sequence entitled “Probe 1” can be used.

It is also assumed that the transmission channel is roughly estimated. This estimation is carried out by estimation means ESTC (FIG. 1) of conventional structure and known in itself, for determining the coefficients Hᵢ of the channel transfer function.

It is also assumed that the Fourier transform window is chosen for eliminating intersymbol interference. Accordingly, the only unknown disturbances are then the gain and quadrature imbalance and Gaussian thermal noise or similar.

If the average thermal noise is not known bin by bin, it can be regarded as constant for all bins.

The bins are sent are {A_{p,i}} where i={0, 1, . . . M-1} is the symbol index and p={0, 1, . . . N-1} denotes the carrier number.

A component {A_{p,i}Hₚ+n_{p,i}} is received at input E (FIG. 1). The imbalance introduces an interaction between the symmetric bins.

More specifically, in OFDM for low (ωᵣ−ωₑ), the imbalance is expressed as a “smear” effect of each bin of frequency f on its frequency symmetric −f (or N−f). Indeed, if for the duration of a symbol, the variation of the angle (ωᵣ−ωₑ) t is low, there will simply be a constant rotation of the contribution of this smear. This rotation γ is known since it is double the angle applied to the derotator during reception of the symbol.

In the absence of thermal noise the following should be received for each bin:

A′_{p,i}=HₚA_{p,i}(1+j a tan(θ))+ H̅_̅{̅N̅-̅p̅}̅A̅_̅{̅N̅-̅p̅,̅i̅}̅e^{jγ,}(α−j tan θ)

With noise, we get bins {X_{p,i}}. The values of a and tan θ will then be determined by maximizing the probability of the received sequence.

Since the noises are independent, this probability is:

$$Pr \{ X \vert a , θ , A \} = {\prod }_{p , i} Pr \{ {X}_{p , i} \vert {A}_{p , i}^{′} \}$$

and since the noise distribution is Gaussian,

$$Pr \{ X \vert {A}^{′} \} = \frac{1}{2 {πσ}^{2}} exp ( - \frac{{\vert X - {A}^{′} \vert}^{2}}{2 {σ}^{2}} )$$

Maximizing the probability is equivalent to minimizing the cost function:

$$C = {\sum }_{p , i} \frac{{\vert {M}_{p , i} \vert}^{2}}{2 {σ}_{p}^{2}} = {\sum }_{p , i} {w}_{p} {\vert {M}_{p , i} \vert}^{2}$$

where wₚ is a coefficient proportional to the signal-to-noise ratio of the carrier p, and M represents the error on each bin:

M_{p,i}=A′_{p,i}−X_{p,i}, that is

M_{p,i}=HₚA_{p,i}(1+j a tan(θ)+ H̅_̅{̅N̅-̅p̅}̅A̅_̅{̅N̅-̅p̅,̅i̅}̅e^{jγ}^{ᵢ}(α−j tan(θ)))−X_{p,i}

Although a complete calculation of α and θ can be performed, an approximation may nevertheless be sufficient in practice by assuming low values of imbalance (e.g. α<0.1 and θ<5°). In practice, estimated or even inaccurate values will give rise to a correction which will reduce the imbalance, while a new measurement will give better values.

The system will converge after a few iterations.

Hence

M_{p,i}=HₚA_{p,i}e^{jγ}+ H̅_̅{̅N̅-̅p̅}̅A̅_̅{̅N̅-̅p̅,̅i̅}̅e^{-jγ}(α−jθ)−X_{p,i}

By cancelling out the derivatives of C with respect to a θ, and γ we get:

Re{ΣωₚH_{N-p}Λ_{N-p,i}e^{jγ}M_{p,i}}=0

Im{ΣwₚH_{N-p}A_{N-p,i}e^{jγ}M_{p,i}}=0

that is

ΣwₚH_{N-p}Λ_{N-p,i}e^{jγ}(HₚΛ_{p,i}e^{jγ}+ H̅_̅{̅N̅-̅p̅}̅Λ̅_̅{̅N̅-̅p̅,̅i̅}̅e^{-jγ}(α−jθ)−X_{p,i})=0

From which we get

$$a - jθ = \frac{{e}^{jγ} \sum {w}_{p} {H}_{N - p} {A}_{N - p , i} ( {X}_{p , i} - {A}_{p , i} {H}_{p} )}{\sum {w}_{p} \vert {H}_{p} {A}_{p , i} \vert} \qquad ( 2 )$$

X−ΛH represents the error vector; the numerator of (2) is the correlation of this error with the conjugate and rotationally compensated symmetrized bins, the denominator a simple normalization. Thus the value 1 can be assigned to the coefficients wₚ.

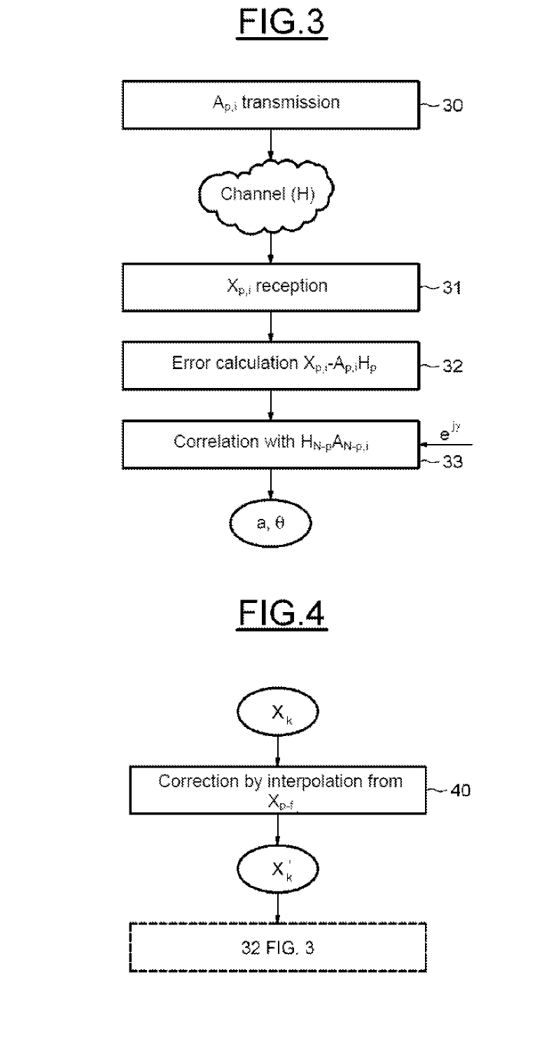

This calculation of formula (2) is illustrated schematically in FIG. 3.

Thus, after transmission (step 30) of the A_{p,i} bins on the channel, the X_{p,i} bins are received (Step 31).

The error vector is calculated (step 32) which is correlated with the conjugate and rotationally compensated symmetrized bins (step 33) for determining the parameters a and θ.

Formula (2) can be calculated on one or more OFDM symbols according to the required precision. The parameters a and 0 can even be determined using only a single bin of a single OFDM symbol.

If the channel is already estimated, coefficients Hᵢ and coefficients wₚ are known. It is sufficient to note the value of the angle of the derotator in the middle of each symbol, an angle that is doubled to obtain the value of the parameter γ.

If the channel is not estimated, it is possible initially to use N symbols (provided that they are different) for performing channel estimation.

One or more of these symbols will then be chosen for calculating the parameters a and θ. The error due to the imbalance on each carrier will only slightly interfere with the estimation of the channel H, these values being decorrelated from one symbol to another.

This calculation algorithm for determining a and θ using formula (2) can be software implemented within an estimation module MEST (FIG. 1).

In the event of a large demodulation frequency shift, the symbol rotates through a considerable angle between its first and last sample, creating an interference between the carriers.

Consequently, it is advantageous, as shown in FIG. 4, that prior to the calculation of the vector error, a correction 40 is made (FIG. 4) to the value of the received modulation coefficient (bin) Xₖ by using an interpolation from the values of the received modulation coefficient X_{p-f} associated with the neighboring carriers of the carrier associated with the modulation coefficient in question Xₖ.

A corrected value X′ₖ is then obtained, which is used in formula (2).

More precisely, if the shift d is a whole number of times the difference Δ between two sub-carriers, the frequency image p will be N-p+d/Δ instead of N-p.

If this shift d, divided by the inter-carrier spacing Δ has a fractional part, the image of the carrier p will affect all the carriers, but especially those around the carrier N-p+d/Δ.

Indeed, a sub-carrier p of frequency fₚ and zero argument in the middle of the symbol, after Fourier transform, will give a signal Sp equal to:

$${S}_{p} = \frac{1}{N} {\sum }_{k = 0}^{N - 1} {e}^{j2π f \frac{k - N / 2}{N}} {e}^{- j2π \frac{kp}{N}} = {e}^{j \frac{π}{N} ( p - f )} \frac{sin π f}{N sin π \frac{( f - p )}{N}}$$

where f=fₚ/Δ

that is

$${S}_{p} = \frac{sin π f}{N} ( cot π \frac{( f - p )}{N} - j ) \approx ( \frac{1}{π ( f - p )} - \frac{j}{N} ) sin π f$$

Before performing the calculation (2), the effects of rotation on the carriers received can therefore be corrected by a convolution.

$${X}_{k}^{′} = \frac{sin π f}{N} [ {\sum }_{p = k - \frac{L}{2}}^{K + \frac{L}{2}} {X}_{p - f} cot π \frac{( f - p )}{N} - j {\sum }_{p = - \frac{N}{2}}^{\frac{N}{2}} {X}_{p - f} ]$$

L is the number of neighboring carriers involved in the convolution; the larger L is, the more accurate the correction will be, but it will require more calculations.

Such a correction can be performed in software by a correction block BCC implemented in the device DIS (FIG. 1).

As just described, the estimation (2) of the parameters a and 0 can be performed on a sequence of M known OFDM symbols.

However, it is also possible to use symbols not known in advance, but reconstituted from the binary information supplied by the “demapper” DMP, or even supplied by the error correction block FEC (a technique known as “decision-aided”).

Having thus described at least one illustrative embodiment of the invention, various alterations, modifications, and improvements will readily occur to those skilled in the art. Such alterations, modifications, and improvements are intended to be within the spirit and scope of the invention. Accordingly, the foregoing description is by way of example only and is not intended as limiting. The invention is limited only as defined in the following claims and the equivalents thereto.

What is claimed is:

1. Method for processing an analog signal received from a transmission channel and modulated by a modulation on N carriers, said received signal carrying a succession of symbols of size N each comprising N complex modulation coefficients respectively associated with N carriers, the method comprising at least one frequency transposition on two phase quadrature processing channels, an analog-to-digital conversion of the transposed signal and digital processing of the converted signal comprising Fourier transform processing of size N preceded by a gain and quadrature correction using a gain correction parameter (a) and a phase correction parameter and a phase shift correction between the signal received and the signal processed by Fourier transform, and followed by an estimation of said gain and phase correction parameters, said estimation including, for at least one modulation coefficient received within at least one symbol and associated with a first carrier, a calculation of the error between the value of this received modulation coefficient and a probable value of the transmitted corresponding modulation coefficient weighted by the corresponding coefficient of the transmission channel transfer function, and a correlation of this error with the complex conjugate value of the transmitted symmetric modulation coefficient weighted by the corresponding coefficient of the transmission channel transfer function, taking said phase shift into account.

2. Method according to claim 1, in which said estimation includes, for at least a plurality of complex modulation coefficients received within at least one symbol and respectively associated with first carriers, a calculation of the errors between the values of these received modulation coefficients and the probable values of the transmitted corresponding modulation coefficients weighted by the corresponding coefficients of the transmission channel transfer function, and a correlation of these errors with the complex conjugate values of the transmitted respective symmetric modulation coefficients weighted by the corresponding coefficients of the transmission channel transfer function, taking said phase shift into account.

3. Method according to claim 2, in which said estimation includes, for at least a plurality of complex modulation coefficients respectively received within at least a plurality of symbols and respectively associated with first carriers, a calculation of the errors between the values of these received modulation coefficients and the probable values of the transmitted corresponding modulation coefficients weighted by the corresponding coefficients of the transmission channel transfer function, and a correlation of these errors with the complex conjugate values of the transmitted respective symmetric modulation coefficients weighted by the corresponding coefficients of the transmission channel transfer function, taking said phase shift into account.

4. Method according to claim 1, in which said probable value of each transmitted corresponding modulation coefficient is a previously known value.

5. Method according to claim 1, in which said digital processing of the converted signal, subsequently to the Fourier transform, includes transformation processing of the binary information symbols optionally followed by error correction processing and said probable value of a transmitted modulation coefficient is a value reconstituted from the binary information obtained from the transformation processing applied to the symbol containing the received corresponding modulation coefficient, after optionally applying the correction processing.

6. Method according to claim 1, further including, prior to the calculation of each error, a correction to the value of the corresponding received modulation coefficient, by using an interpolation from the values of the received modulation coefficients associated with the neighboring carriers of the carrier associated with the modulation coefficient in question.

7. Method according to claim 1, in which the modulation is an OFDM modulation.

8. Device for estimating a gain correction parameter and a phase correction parameter, said parameters being usable in a gain and quadrature correction stage for correcting two quadrature processing channels of a transposed digital signal originating from an analog signal received from a transmission channel and modulated by a modulation on N carriers, said received signal carrying a succession of symbols of size N each comprising N complex modulation coefficients respectively associated with the N carriers, the estimation device comprising an estimation module capable of being coupled to a Fourier transform module of size N coupled upstream to said gain and quadrature correction stage and to a stage for correcting the phase shift between the signal received and the signal processed by the Fourier transform module, the estimation module being configured for performing an estimation of said gain and phase correction parameters including, for at least one modulation coefficient received within at least one symbol and associated with a first carrier, a calculation of the error between the value of this received modulation coefficient and a probable value of the transmitted corresponding modulation coefficient weighted by the corresponding coefficient of the transmission channel transfer function, and a correlation of this error with the complex conjugate value of the transmitted symmetric modulation coefficient weighted by the corresponding coefficient of the transmission channel transfer function, taking said phase shift into account.

9. Device according to claim 8, in which the estimation module is further configured for performing said estimation including, for at least a plurality of complex modulation coefficients received within at least one symbol and respectively associated with first carriers, a calculation of the errors between the values of these received modulation coefficients and the probable values of the transmitted corresponding modulation coefficients weighted by the corresponding coefficients of the transmission channel transfer function, and a correlation of these errors with the complex conjugate values of the transmitted respective symmetric modulation coefficients weighted by the corresponding coefficients of the transmission channel transfer function, taking said phase shift into account.

10. Device according to claim 9, in which the estimation module is further configured for performing said estimation including, for at least a plurality of complex modulation coefficients respectively received within a plurality of symbols and respectively associated with first carriers, a calculation of the errors between the values of these received modulation coefficients and the probable values of the transmitted corresponding modulation coefficients weighted by the corresponding coefficients of the transmission channel transfer function, and a correlation of these errors with the complex conjugate values of the transmitted respective symmetric modulation coefficients weighted by the corresponding coefficients of the transmission channel transfer function, taking said phase shift into account.

11. Device according to claim 8, in which said probable value of each transmitted corresponding modulation coefficient is a previously known value.

12. Device according to claim 8, in which said probable value of a transmitted modulation coefficient is a value reconstituted from the binary information, optionally corrected by a correction process, and obtained from binary information symbol transformation processing applied to the symbol containing the received corresponding modulation coefficient.

13. Device according to claim 8, further including a correction block configured for making a correction to the value of the corresponding received modulation coefficient, by using an interpolation from the values of the received modulation coefficients associated with the neighboring carriers of the carrier associated with the modulation coefficient in question, and supplying said corrected value to the estimation module.

14. Device according to claim 8, in which the modulation is an OFDM modulation.

15. Reception chain, including an input coupled to a transmission channel and configured for receiving an analog signal modulated according to a modulation on N carriers, said received signal carrying a succession of symbols of size N each comprising N complex modulation coefficients respectively associated with the N carriers, frequency transposition means configured for performing at least one frequency transposition on two phase quadrature processing channels, conversion means configured for performing analog-to-digital conversion of the transposed signal, and digital processing means coupled to the output of the conversion means and comprising a Fourier transform module of size N coupled upstream to a gain and quadrature correction stage using a gain correction parameter (a) and a phase correction parameter and to a stage for correcting the phase shift between the signal received and the signal processed by the Fourier transform module, and coupled downstream to an estimation device according to claim 8.

16. Apparatus, including a reception chain according to claim 15.
